(19) United States
(12) Patent Application Publication
(10) Pub. No.: US 2013/0265355 A1
(43) Pub. Date: Oct. 10, 2013

(54) PRINTING APPARATUS AND PRINTING METHOD

(71) Applicant: SEIKO EPSON CORPORATION, Tokyo (JP)

(72) Inventors: Hironori SATO, Shiojiri (JP); Tomohiro SAYAMA, Matsumoto (JP); Nagatoshi KASAHARA, Matsumoto (JP); Masako FUKUDA, Shiojiri (JP); Hiroshi MUKAI, Shiojiri (JP); Toshihiro SHINBARA, Matsumoto (JP)

(73) Assignee: Seiko Epson Corporation, Tokyo (JP)

(21) Appl. No.: 13/853,634

(22) Filed: Mar. 29, 2013

(30) Foreign Application Priority Data
Apr. 9, 2012 (JP) 2012-088184
Mar. 28, 2013 (JP) 2013-070352

(51) Int. Cl. B41J 2/045

(52) U.S. Cl. CPC B41J 2/04541
USPC 347/10

(57) ABSTRACT

A printing apparatus includes a head having a nozzle ejecting an ink having thermoplastic resin particles and a viscosity of 2.1 mPa·s or more at 50° C., a pressure chamber, and a drive element; a medium having ink-unabsorbable characteristics and a length of 64 inches or less in a predetermined direction; a movement mechanism which moves the head in the predetermined direction; a heating unit which heats the medium; and a control unit which causes the movement mechanism to move the head in the predetermined direction and applies a drive waveform generating a pressure change in the ink inside the pressure chamber, to the drive element. The control unit applies a micro-vibration waveform having a size which does not allow the ink to be ejected from the nozzle onto the drive element corresponding to the nozzle if the nozzle does not eject the ink.

The entire disclosure of Japanese Patent Application Nos. 2012-088184, filed Apr. 9, 2012 and 2013-070352, filed Mar. 28, 2013 are expressly incorporated by reference herein.

### BACKGROUND

1. Technical Field

The present invention relates to a printing apparatus and a printing method.

2. Related Art

As a printing apparatus, an ink jet printer (hereinafter, referred to as a printer) having a head which ejects an ink from nozzles has been known. In recent years, there has been a demand for printing an image on various types of media such as a sheet of paper, cloth, or plastic film. For example, in order to print the image on an ink-unabsorbable medium such as the plastic film, a printer which uses the ink including thermoplastic resin particles has been proposed (for example, refer to JP-A-2010-221670). By using the ink including the thermoplastic resin particles, it is possible to form a rigid resin film on the medium after the ink is dried and thus to ensure antifriction characteristics of a printed matter.

In addition, the ink landed on the medium of the ink-unabsorbable medium is easily fluidified. Therefore, in order to rapidly dry the ink landed on the medium and to suppress the ink from being fluidified, there is a need to perform printing while heating the medium. However, heating the medium may also cause a nozzle formation surface of a head to be heated and an ink solvent to be evaporated from the nozzle, thereby the nozzle being easily clogged. If the nozzle is clogged, an ejection failure occurs in that a predetermined amount of the ink cannot be ejected from the nozzle or ink droplets ejected from the nozzle deviate from their original blowing direction, and thereby a printed image is degraded in quality.

### SUMMARY

An advantage of some aspects of the invention is to provide a printing apparatus and a printing method which suppress nozzle clogging.

According to an aspect of the invention, there is provided a printing apparatus including: a head having a nozzle ejecting an ink which includes thermoplastic resin particles and has a viscosity of 2.1 mPa·s or more at 50° C., a pressure chamber communicating with the nozzle, and a drive element corresponding to the nozzle and the pressure chamber; a medium which has ink-unabsorbable characteristics and a length of 64 inches or less in a predetermined direction; a movement mechanism which moves the head in the predetermined direction; a heating unit which heats the medium; and a control unit which causes the movement mechanism to move the head in the predetermined direction and applies a drive waveform generating a pressure change in the ink inside the pressure chamber, to the drive element, wherein the control unit applies a micro-vibration waveform having a size which does not allow the ink to be ejected from the nozzle onto the drive element corresponding to the nozzle if the nozzle do not eject the ink.

Other characteristics of the invention will be apparent from the description of the specification and the accompanying drawings.

### BRIEF DESCRIPTION OF THE DRAWINGS

The invention will be described with reference to the accompanying drawings, wherein like numbers reference like elements.

FIG. 1A is a block diagram illustrating an overall configuration of a print system, and FIG. 1B is a schematic cross-sectional view for explaining a structure of a head.

FIG. 2A is a schematic cross-sectional view of a printing when apparatus viewed from a movement direction of the head, and FIG. 2B is a schematic top view of the printing apparatus.

FIG. 3 is a view for explaining a drive signal driving a piezoelectric element.

FIG. 4 is a view for explaining a head drive circuit.

FIG. 5A is a flow illustrating a printing method in Embodiment 1, and FIG. 5B is a view for explaining a flushing process.

FIG. 6 is a table illustrating an evaluation result on an ink ejection state from a nozzle by changing strength of a micro-vibration waveform and a movement distance of a head.

FIG. 7 is a view for explaining a printing method of Embodiment 2.

### DESCRIPTION OF EXEMPLARY EMBODIMENTS

### Outline of Disclosure

At least the followings will be apparent from the description of the specification and the accompanying drawings.

That is, a printing apparatus according to an aspect of the invention includes: a head having a nozzle ejecting an ink which includes thermoplastic resin particles and has a viscosity of 2.1 mPa·s or more at 50° C., a pressure chamber communicating with the nozzle, and a drive element corresponding to the nozzle and the pressure chamber; a medium which has ink-unabsorbable characteristics and a length of 64 inches or less in a predetermined direction; a movement mechanism which moves the head in the predetermined direction; a heating unit which heats the medium; and a control unit which causes the movement mechanism to move the head in the predetermined direction and applies a drive waveform generating a pressure change in the ink inside the pressure chamber, to the drive element, wherein the control unit applies a micro-vibration waveform having a size which does not allow the ink to be ejected from the nozzle onto the drive element corresponding to the nozzle if the nozzle do not eject the ink.

According to such a printing apparatus, nozzle clogging can be suppressed and a printed image can be suppressed from being degraded in an image quality.

In the printing apparatus, the micro-vibration waveform may include a first element which expands the pressure chamber and a second element which contracts the pressure chamber and wherein an upper limit value of an electric potential difference between a boiling point and a termination end electric potential of the first element is an electric potential difference which does not allow the ink to be ejected from the nozzle.

In this case, the ink can be prevented from being ejected from the nozzle toward pixels on the medium on which dots should not be formed.

In the printing apparatus, the micro-vibration waveform may include a first element which expands the pressure chamber and a second element which contracts the pressure chamber and wherein a lower limit value of an electric potential difference between a boiling point and a termination end electric potential of the first element may be 35% of an electric potential difference between the highest electric potential and the lowest electric potential in an ejection waveform applied to the drive element when the ink is ejected from the nozzle.

In this case, even when printing an image on the medium having the maximum length of 64 inches in the predetermined direction, the nozzle clogging can be suppressed.

In the printing apparatus, ink reception units receiving the ink ejected from the nozzle may be disposed in non-print regions at both sides in the predetermined direction, and wherein the control unit may cause the ink to be ejected from the nozzle toward the ink reception units in the non-print regions at both sides in the predetermined direction each time the movement mechanism moves the head in the predetermined direction.

In this case, the nozzle clogging can be suppressed.

In the printing apparatus, ink reception units receiving the ink ejected from the nozzle may be disposed in non-print regions at both sides in the predetermined direction, and wherein the control unit may cause the ink to be ejected from the nozzle toward the ink reception units after causing the movement mechanism to moves the head to one side in the predetermined direction, when moving the head to return to the non-print region of the other side in the predetermined direction.

In this case, printing time can be shortened as much as possible while suppressing the nozzle clogging.

In addition, according to another aspect of the invention, there is provided a method of printing an image on a medium which has ink-unabsorbable characteristics and a length of 64 inches or less in a predetermined direction by using a head including a nozzle ejecting an ink which includes thermoplastic resin particles and has a viscosity of 2.1 mPa·s or more at 50° C., a pressure chamber communicating with the nozzle, and a drive element corresponding to the nozzle and the pressure chamber, the method comprising: moving the head in the predetermined direction, toward the medium which is being heated; and applying a drive waveform generating a pressure change in the ink inside pressure chamber to a drive element; and wherein he control unit applies a micro-vibration waveform having a size which does not allow the ink to be ejected from the nozzle onto the drive element corresponding to the nozzle if the nozzle do not eject the ink.

According to such a printing method, nozzle clogging can be suppressed and a printed image can be suppressed from being degraded in an image quality. Printing System

An embodiment will be described by assuming a “printing apparatus” as an ink jet printing apparatus (hereinafter, referred to as a printer) and by exemplifying a case where a printing apparatus and computer are connected to each other.

A printer 1 of the present embodiment prints an image on an ink-unabsorbable medium. The ink-unabsorbable medium is a medium which has no ink absorption layer. The ink-unabsorbable medium, for example, includes plastic films which are not surface-treated for ink jet printing, a medium where plastic coating is formed or plastic film is bonded on a base member such as paper, and the like. Here, the so called plastic includes polyvinyl chloride, polyethylene terephthalate, polycarbonate, polystyrene, polyurethane, polyethylene, polypropylene and the like.

In addition, the printer 1 of the present embodiment uses an ink that is an ink (hereinafter, referred to as a resin ink) including thermoplastic resin particles and a viscosity is 2.1 mPa·s or more at 50° C. An example of such an ink will be described below.

The ink used in the present embodiment does not substantially include glycerin having a boiling point of 290° C. under one atm. If the ink substantially includes the glycerin, a drying property of the ink is significantly degraded. As a result, in various recording media, particularly, in the recording medium having ink unabsorbable characteristics or low absorbable characteristics, not only irregularity in a concentration difference of the image is noticeable, but also the ink may not be fixed. Furthermore, it is preferable that alkyl polyols (except for the above-described glycerin) whose boiling point is 280° C. or more under one atm or the equipment is not substantially included.

Here, the “not substantially included” in the present specification means that an amount or more which is sufficiently significant when adding it is not included an intention. To speak this quantitatively, it is preferable not to include the glycerin of 1.0 mass % or more with respect to a total weight (100 mass %), more preferable not to include 0.5 mass % or more, more preferable not to include 0.1 mass % or more, not to include still further preferably 0.05 mass % or more, particularly preferable not to include 0.01 mass % or more, and most preferable not to include 0.001 mass % or more.

Hereinafter, additives (components) will be described which are included or may be obtained by being included in the ink of the present embodiment.

The ink of the present embodiment may include color materials. The color materials are selected from pigments and dyes.

In the present embodiment, by using the pigments as the color material, a light resistance of the ink can be improved. The pigments may use any one of inorganic pigments and organic pigments.

The inorganic pigments are not particularly limited, but may include for example, carbon blacks, iron oxides, and titanium oxides and silica oxides.

The organic pigments are not particularly limited, but may include for example, quinacridone pigments, quinacridone quinone pigments, dioxazine pigments, phthalocyanine pigments, anthrapyrimidine pigments, ansansuron pigments, indanthrone pigments, flavanthrone pigments, perylene pigments, diketopyrrolopyrrole pigments, perinone pigments, quinophthalone pigments, anthraquinone pigments, thioindigo pigments, benzimidazolone pigments, isoindolinone pigments, azomethine pigments, and azo pigments. As specific examples of the organic pigments, the followings may be included.

The pigment to be used for a cyan ink may include C.I. pigment blues 1, 2, 3, 15, 15:1, 15:2, 15:3, 15:4, 15:6, 15:34, 16, 18, 22, 60, 65 and 66, and C.I. vat blues 4 and 60. Among them, it is preferable to use at least any one of C.I. pigment blues 15:3 and 15:4.

The pigment to be used for a magenta ink may include C.I. pigment reds 1, 2, 3, 4, 5, 6, 7, 8, 9, 10, 11, 12, 14, 15, 16, 17, 18, 19, 21, 22, 23, 30, 31, 32, 37, 38, 40, 41, 42, 48 (Ca), 48 (Mn), 57 (Ca), 57:1, 88, 112, 114, 122, 123, 144, 146, 149, 150, 166, 168, 170, 171, 175, 176, 177, 178, 179, 184, 185, 187, 202, 209, 219, 224, 245, 254 and 264, and C.I. pigment violets 19, 23, 32, 33, 36, 38, 43 and 50. Among them, it is preferable to use one or more types selected from a group which is made of C.I. pigment red 122, C.I. pigment red 202 and C.I. pigment violet 19.

The pigment used in a yellow ink may include C.I. pigment yellows 1, 2, 3, 4, 5, 6, 7, 10, 11, 12, 13, 14, 16, 17, 24, 34, 35, 37, 53, 55, 65, 73, 74, 75, 81, 83, 93, 94, 95, 97, 98, 99, 108, 109, 110, 113, 114, 117, 120, 124, 128, 129, 133, 138, 139, 147, 151, 153, 154, 155, 167, 172, 180, 185 and 213. Among them, it is preferable to use one or more types selected from a group which is made of C.I. pigment yellows 74, 155, and 213.

In addition, as the pigment used in the other color ink, such as the green ink, orange ink, and the like except for the above-mentioned colors, a known pigment in the related art may be included.

An average particle diameter of the pigment is preferably 250 nm or less in order to suppress the nozzle clogging and ensure a better ejection stability. In addition, the average particle diameter in the present specification is based on a volume. As a measurement method, for example, a measurement can be performed by a particle size distribution measurement apparatus using a laser diffraction scattering method as a measurement principle. As the particle size distribution measurement apparatus, for example, there is a particle size analyzer (for example, microtrac UPA manufactured by Nikkiso Co., Ltd.) and using a dynamic light scattering method as the measurement principle, and the like.

In the present embodiment, it is possible to use the pigment as the color material. The pigment is not particularly limited thereto, but acid dyes, direct dyes, reactive dyes and basic dyes may be used.

The content of the color material is preferably 0.4 mass % to 12 mass % with respect to the total mass (100 mass %) of the ink, and more preferably 2 mass % to 5 mass %.

The ink in the present embodiment includes the resin. Owing that the ink includes the resin, a resin film is formed on the recording medium and as a result, the ink is sufficiently fixed on the recording medium, and thereby there is an effect which mainly ensures better antifriction characteristics for the image. Therefore, a resin emulsion is preferably the thermoplastic resin.

Since an advantageous effect can be obtained in that a heat distortion temperature of the resin hardly causes the head clogging to occur and leads to antifriction characteristics on the recorded matter, the temperature is preferably 40° C. or more, and more preferably 60° C. or more.

Here, in the present specification, the “heat distortion temperature” is a temperature value represented by a glass transition temperature (Tg) or a minimum film forming temperature (MFT). In other words, the “heat distortion temperature is 40° C. or more” means that any one of the Tg or MFT may be 40° C. or more. In addition, since the MFT is more easily understood than the Tg in when determining a superiority in terms of re-dispersible of the resin, the heat distortion temperature is preferably the temperature value represented by the MFT. If it is the ink with the superior re-dispersion of the resin, a head 31 is hardly clogged since the ink is not fixed.

In the present specification, the Tg is described with the value measured by a differential scanning calorimetry measurement method. Further, the MFT in the present specification is described with the value measured by ISO 2115:1996 (title: measurement of a plastic-polymer-distribution-white point temperature and a minimum film forming temperature).

Specific examples of the above-described thermoplastic resin are not particularly limited, but may include poly(meth)acrylates or copolymers thereof, polyacrylonitriles or copolymers thereof, (meth)acrylic polymers such as polycyanoacrylates, polyacrylamides, and poly(meth)acrylic acids, polyethylenes, polypropylenes, polybutenes, polyisobutylenes, and polystyrenes, and copolymers thereof, and polyolefin polymers such as petroleum resins, coumarone-indene resins and terpene resins, polyvinyl acetates or copolymers thereof, vinyl acetates or vinyl alcohol polymers such as polyvinyl alcohols, polyvinyl acetals and poly vinyl ethers, polyvinyl chlorides or a copolymers thereof, halogen polymers including polyvinylidene chlorides, fluorine resins, fluorine rubbers and the like, polyvinyl carbazoles, polyvinyl pyrrolidones or copolymers thereof, polyvinylpyridines, and nitrogen vinyl polymers including polyvinylimidazoles, polybutadienes or copolymers thereof, polychloroprenes, and diene polymers such as polyisoprenes (butyl rubber), and other ring-opening polymerization type resins, condensation polymerization type resins, and natural polymer resins.

The content of the resin is more preferably 1 mass % to 30 mass % with respect to the total mass (100 mass %) of the ink, and more preferably 1 mass % to 5 mass %. When the content is within the above range, glossiness and antifriction characteristics of the image to be formed can be made further excellent.

In addition, as examples of the resin, a dispersant resin, resin emulsion, wax or the like may be included in the ink.

The ink of the present embodiment may include the resin emulsion. When the recording medium is heated, it is preferable to form the resin film using the resin emulsion with wax (emulsion), and in this case, the ink is sufficiently fixed on the recording medium, thereby an effect leading to good antifriction characteristics of the image being obtained. The recorded matter which is recorded using the ink including the resin emulsion having the above effect is excellent in the antifriction characteristics on the ink-unabsorbable or low absorbable recording medium.

In addition, the resin emulsion function as a binder is included in the ink in an emulsion state. By including the resin functioning as the binder in the ink in the emulsion state, the viscosity in the ink jet recording method is easily adjusted to a proper range, and thus the ink will have an excellent preservation stability and ejection stability.

The resin emulsion is not limited to the following, but may include, for example, (meth)acrylic acids, (meth)acrylic acid esters, acrylonitriles, cyanoacrylates, acrylamides, olefin, styrenes, vinyl acetates, vinyl chlorides, vinyl alcohols, vinyl ethers, vinyl pyrrolidones, vinyl pyridines, vinyl carbazoles, vinyl imidazoles, and homopolymers of vinylidene chloride or copolymers, fluorine resins, and natural resins, and the like. Among them, at least any one of (meth)acrylic resins and styrene-(meth)acrylic acid copolymer resins is preferable, at least any one of acrylic resins and styrene-acrylic acid copolymer resins is further preferable, and styrene-acrylic acid copolymer resins are more preferable. In addition, the above copolymer may be any one of random copolymer, block copolymer, alternating copolymer and the graft copolymer.

For better preservation stability and ejection stability of the ink, the average particle diameter of the resin emulsion is preferable in a range of 5 nm to 400 nm, more preferably in the range of 20 nm to 300 nm.

The content of the resin emulsion among resins is preferable in the range of 0.5 mass % to 7 mass % with respect to the total mass (100 mass %) of the ink. If the content is within the above range, since it is possible to lower a solid content concentration, the ejection stability can be made better.

The ink of the present embodiment may include the wax. If the ink includes the wax, the ink is excellently fixed on the ink-unabsorbable and low absorbable recording medium. The emulsion type wax among the waxes is more preferable. The above waxes are not limited to the followings, but for example, may include polyethylene waxes, paraffin waxes, and polyolefin waxes, and among them, polyethylene waxes are preferable, which will be described later.

In this specification, the “wax” mainly represents the one in which solid wax particles are dispersed in water, using surfactants described below.

The ink including the polyethylene wax allows the ink to have excellent antifriction characteristics.

For better preservation stability and ejection stability of the ink, the average particle size of the polyethylene wax is preferably in the range of 5 nm to 400 nm, and more preferably in the range of 50 nm to 200 nm.

The content of the polyethylene wax (in terms of solid content) is preferably in the range of 0.1 mass % to 3 mass %, more preferably 0.3 mass % to 3 mass %, further more preferably 0.3 mass % to 1.5 mass % with respect to the total mass (100 mass %) of the ink independently to each other. If the content is within the above range, even on the ink-unabsorbable or low absorbable recording medium, it is possible to satisfactorily solidify and fix the ink and thereby the preservation stability and ejection stability of the ink becomes more excellent.

The ink of the present embodiment may include the surfactant. The surfactant is not limited to the followings, but for example, may include a nonionic surfactant. The nonionic surfactant has a function of uniformly spreading the ink on the recording medium. Therefore, when performing the ink jet recording using the ink including nonionic the surfactant, a high-definition image having little blur can be obtained. Such a nonionic surfactant is not limited to the followings, but for example may include silicones, polyoxyethylene alkyl ethers, polyoxypropylene alkyl ethers, polycyclic phenyl ethers, sorbitan derivatives, and fluorine-based surfactants and the like. Among them, silicone-based surfactants are preferable.

The content of the surfactant is preferably in the range from 0.1 mass % to 3 mass % with respect to the total weight (100 mass %) of the ink, so as to ensure the excellent preservation stability and ejection stability of the ink.

The ink of the present embodiment may also include water. In particular, when the ink is an aqueous ink, the water is a medium mainly configuring the ink, and when the recording medium is heated in the ink jet recording, the water is evaporated and scattered.

The ink of the present embodiment may include a volatile water-soluble organic solvent which is known in the related art. However, as described above, the ink of the present embodiment may not substantially include (boiling point is 290° C. under one atm) the glycerin which is a type of organic solvents, and preferably may not substantially include no alkyl polyols (except for the above glycerin) having a boiling point of 280° C. or more under one atm or the equivalent.

The ink of the present embodiment may further include preservatives, fungicides, rust inhibitors, chelating agents, and the like in addition to the components described above.

The ink composition of the present embodiment preferably includes an aprotic polar solvent. By including the aprotic polar solvent, in order to dissolve the resin particles described above that are included in the ink, the nozzle clogging can be effectively prevented during the ink jet recording. In addition, the adhesion to the image is improved since there is a property of dissolving the recording medium made of vinyl chloride.

The aprotic polar solvent is not particularly limited, but may preferably include one type or more of the aprotic polar solvents selected from pyrrolidones, lactones, sulfoxides, imidazolidinones, sulfolane type urea derivatives, dialkyl amides, cyclic ethers and amides ethers. As representative examples of pyrrolidone, there are pyrrolidone, 2-pyrrolidone, N-methyl-2-pyrrolidone, N-ethyl-2, as representative examples of lactones, there are γ-butyrolactone, γ-valerolactone and ε-caprolactone, as representative examples of the sulfoxides, there are dimethyl sulfoxide, and tetramethylene sulfoxide, as representative examples of imidazolidinone species, there are 1,3-dimethyl-2-imidazolidinone, as representative examples of the sulfolanes, there are sulfolanes, and dimethyl sulfolanes, as representative examples of urea derivatives, there are dimethylurea and 1,1,3,3-tetramethylurea-dimethylureas, as representative examples of dialkyl amides, there are dimethylformamides and dimethylacetamides, and as representative examples of cyclic ethers, there 1,4-dioxanes and tetrahydrofurans. Among the above, in the viewpoint of the above-mentioned the effect, pyrrolidones, lactones, sulfoxides, amides and ethers are particularly preferable. 2-pyrrolidone is most preferable.

The content of the above-mentioned aprotic polar solvent is preferably in a range 3 mass % to 30 mass %, more preferably 8 mass % to 20 mass % with respect to the total mass (100 mass %) of the ink.

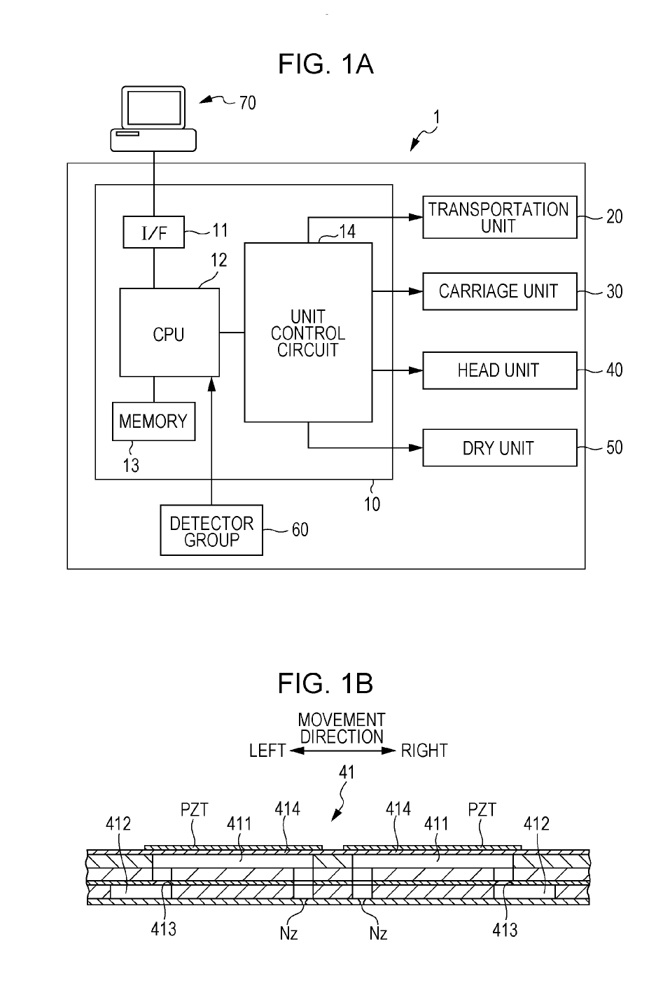

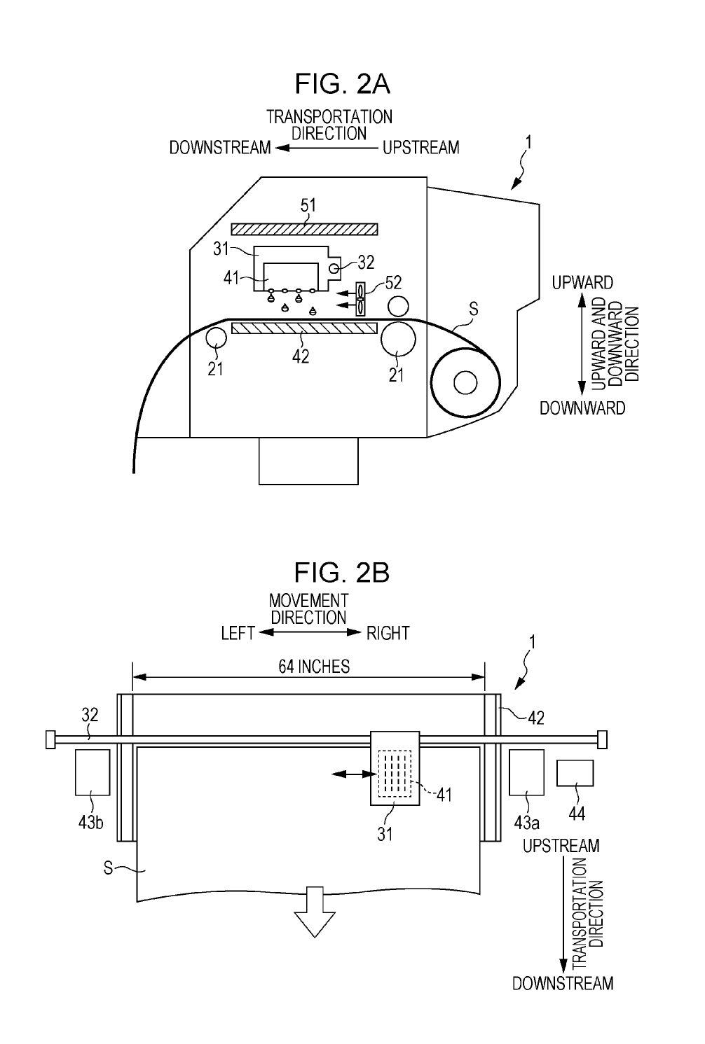

FIG. 1A is a block diagram illustrating the overall configuration of the printing system, FIG. 1B is a schematic cross-sectional view illustrating the structure of the head 41 (a part), FIG. 2A is a schematic cross-sectional view of the printer 1 when viewed from the movement direction of the head 41, and FIG. 2B is a schematic top view of the printer 1. The printer 1 includes a controller 10, a transportation unit 20, a carriage unit 30, a head unit 40, a drying unit 50, and a detector group 60. The printer 1 is connected to a computer 70 to be able to communicate with it, and by a printer driver that is installed in the computer 70, print data which causes the printer 1 to print an image is prepared, and then the print data is transmitted to the printer 1.

The controller 10 inside the printer 1 is to perform an overall control in the printer 1. An interface unit 11 transmits and receives data to and from the computer 70 which is an external device. A CPU 12 is an arithmetic processing unit for performing an overall control of the printer 1, and controls each unit via a unit control circuit 14. A memory 13 is to secure a region for storing programs of the CPU 12 or a work area or the like. The detector group 60 monitors situations inside the printer 1, and outputs the detection result to the controller 10.

The transportation unit 20 to set a medium S (ink-unabsorbable medium) which is a target to print the image at a position for printing by the transport roller 21, and transports the medium S to a downstream side of the transportation direction. In addition, in FIG. 2A, a continuous medium wound in a roll shape is illustrated, without being limited thereto, a medium that has been cut to a predetermined size may be used.

The carriage unit 30 (corresponding to the movement mechanism) is to move a head 41 which is mounted on a carriage 31 along a guide rail 32 in the movement direction (corresponding to the predetermined direction) which is a direction intersecting (in an orthogonal direction generally) the transportation direction of the medium S. In addition, in the printer 1 of the present embodiment, the maximum printable length in the movement direction of the medium S is 64 inches. Therefore, the carriage 31 can move in the length of 64 inches or more in the movement direction.

The head unit 40 includes the head 41 which ejects the ink onto the medium S, a platen 42 on which supports the medium S from a back surface, ink reception units 43a and 43b, and a cap 44. As illustrated in FIG. 1B, the head 41 includes a plurality of nozzles Nz which eject the ink, a plurality of pressure chambers 411 provided for each of the nozzles Nz, common ink chambers 412 provided for each color of the ink, an ink supply path 413 which connects the pressure chambers 411 and the common ink chambers 412, and a plurality of piezoelectric elements PZT provided for each of the nozzles Nz (corresponding to a driving element). The common ink chamber 412 communicates with the plurality of pressure chambers 411 filled with the same color inks through the ink supply path 413, and the respective pressure chambers 411 communicate with the corresponding nozzles Nz. The ink stored in the ink cartridge is firstly supplied to the common ink chambers 412, and moved to the pressure chambers 411 and then, ejected from the nozzles Nz.

In addition, openings of the nozzles Nz are formed on the lower surface of the head 41, and on the lower surface of the head 41, nozzle openings for each color of ink to be ejected are arranged to form nozzle rows in the transportation direction. For example, a black nozzle row K for ejecting a black ink and, a cyan nozzle row C for ejecting a cyan ink, a magenta nozzle row M for ejecting a magenta ink, a yellow nozzle row Y for ejecting a yellow ink are configured on the lower surface of the head 41.

In addition, the piezoelectric element PZT is bonded to an elastic plate 414 to configure the pressure chamber 411 corresponding to each piezoelectric element PZT. If an ejection waveform Wa generated in a drive signal COM output from the controller 10 is applied to the piezoelectric element PZT, depending on the electric potential of the ejection waveform Wa, a deflection amount of the piezoelectric element PZT to the pressure chamber 411 side is changed. As a result, the volume of the pressure chamber 411 is changed (the pressure chamber 411 is expanded and contracted), the pressure is changed in the ink inside the pressure chamber 411, and finally ink droplets are ejected from the nozzles Nz which communicates with the pressure chamber 411.

The ink reception units 43a and 43b and the cap 44 are disposed in the non-print regions (that is, the region through which the medium S does not pass) of the end portion in the movement direction of the head 41, and are disposed at a position capable of opposing the lower surface of the head 41 moving in the movement direction by the carriage 31. The ink reception units 43a and 43b receive the ink ejected from the nozzles Nz during a flushing process. The cap 44 comes into close contact with the lower surface of the head 41 during a cleaning process, sucking the ink from the nozzles Nz using a pump, or the cap 44 comes into close contact with the lower surface of the head 41 when stopping the printing, and thereby seals the nozzle opening to suppress the evaporation of the ink solvent from the nozzle Nz.

The dry unit 50 is to dry the ink landed on the medium S and has a heater 51 (for example, infrared heater) and a fan 52. As illustrated in FIG. 2A, the heater 51 (corresponding to the heating unit) is located at further upper position than the carriage 31 and the head 41 and is disposed at the position opposing the platen 42 to heat the entire region of the medium S supported by the platen 42. The fan 52 blows wind between the lower surface of the head 41 and the medium S.

As described above, the printer 1 of the present embodiment prints the image by ejecting the resin ink onto the medium S having the ink-unabsorbable characteristics. The resin ink landed on the ink-unabsorbable medium S is easily fluidified on the medium S. Therefore, if the resin ink is not sufficiently dried to fix the resin ink on the landed position, it may be impossible to print a desired image. Thus, by heating the medium S using the heater 51 and blowing the wind to the resin ink on the medium S using the fan 52, a drying performance of the resin ink landed on the medium S can be enhanced and the fluidity of the resin ink on the medium S can be suppressed.

In addition, it is possible to suppress the uneven heating of the heater 51 using the wind of the fan 52. Moreover, the surface temperature of the medium S is preferably from 45° C. to 60° C., and the temperature of the heater 51 is preferably set to be from 250° C. to 300° C. In addition, in order to prevent an excessive heating of the head 41 due to the heat of the heater 51, an insulation or heat dissipation member is preferably provided on the upper surface or the side surface of the carriage 31. In addition, in the present embodiment, the heating of the medium S is performed from above the head 41, but is not limited thereto, the heater may be provided inside the platen 42 to heat the medium S from below. In addition, the medium S before printing may be heated at the further upstream side in the transportation direction than the platen 42, and the medium S after printing may be heated at the further downstream side in the transportation direction than the platen 42. In addition, the fan 52 may not be provided.

In addition, due to the heat of the heater 51, an ambient temperature inside the printer 1 is increased (for example, to 40° C.), and the temperature of the ink inside the head 41 is also increased (for example, to 50° C.). Though the viscosity is lowered according to an increase in the temperature, if the viscosity of the ink is too lowered, the ink cannot be stably ejected from the nozzles Nz. However, in the printer 1 of the embodiment, since the resin ink having the viscosity of 2.1 mPa·s or more at 50° C. is used, the ink can be stably ejected from the nozzles Nz even under high temperature environments.

In the printer 1 of this configuration, the controller 10 (corresponding to the control unit) alternately repeats an ejection operation to eject the ink from the nozzles Nz while moving the head 41 in the movement direction using the carriage 31 with respect to the medium S having the length of 64 inches or less in the movement direction, and a transportation operation to transport the medium S to the downstream side in the transportation direction of the transportation unit 20. As a result, since the dots are formed after the ejection operation, in a position different from the position of the dots formed by the preceding ejection operation, a two-dimensional image is printed on the medium S. In addition, in the following description, the operation in which the head 41 is moved once in the movement direction is also referred to as a “pass”.

### Embodiment 1

### Regarding Nozzle Nz Clogging

There is a case where the ink has not been ejected from the nozzles Nz which are not frequently used during the printing over a relatively long period of time, and during the period, the ink solvent is evaporated from the nozzle opening and the ink inside the nozzles Nz or inside the pressure chambers 411 is increased in the viscosity, or a foreign matter such as paper powder or dust is mixed into the nozzles Nz to clog the nozzles Nz. In particular, in the printer 1 of the present embodiment, since the resin ink is ejected onto the ink-unabsorbable medium S, it is necessary to dry the resin ink landed on the medium S in order to suppress the fluidity of the resin ink on the medium S, and accordingly, the high temperature heater 51 for heating the medium S is provided in the printer 1. Therefore, under the influence of the heat from the heater 51 or a radiant heat from the medium S, the nozzle formed surface of the head 41 (lower surface) is heated. As a result, the ink solvent is easily evaporated from the nozzles Nz, and the nozzles Nz are easily clogged. For more detail, the viscosity of the ink inside the nozzles Nz is increased by the ink solvent is evaporated from nozzles Nz. Therefore, an ejection failure and nozzle clogging is occurs. Also, for example, when the temperature of the heater 51 is set in the range of 250° C. to 300° C., and when the surface temperature of the medium is 45° C. to 60° C., the temperature of the nozzle surface rises up to 40° C. to 55° C. As described as above, if the temperature of the nozzle surface is higher than MFT, the resin ink form the resin film in the nozzles Nz, and it cause nozzle clogging. In addition, for example, if the ink having decreased amount of humectant is used in order to enhance the drying property of the resin ink, it is easily evaporated the ink solvent from the nozzles Nz. Thus, the nozzles Nz are further easily clogged.

If the nozzles Nz are clogged, the ink is not ejected from the nozzles Nz or the defined amount of the ink is not ejected then, if the blowing direction of the ink droplets ejected from the nozzle Nz is deviated, the ejection failure occurs and thus the image is degraded in the printing quality. Therefore, an object of the present embodiment is to suppress the clogging of nozzle Nz during the printing and to suppress the ink ejection failure from the nozzles Nz.

### Drive of Head 41

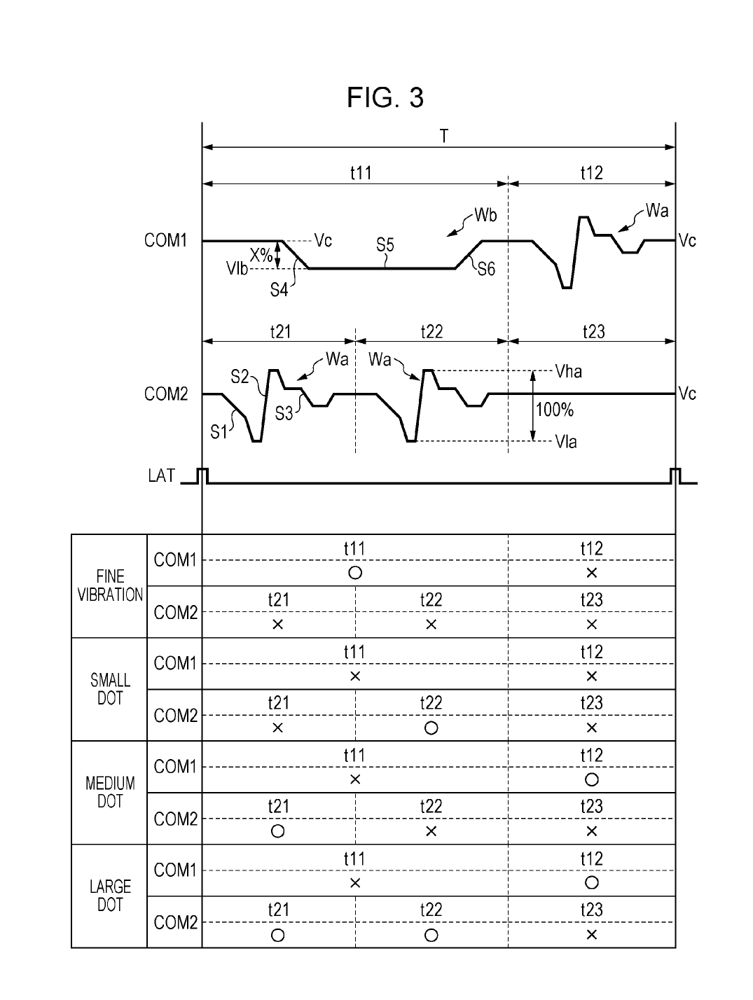

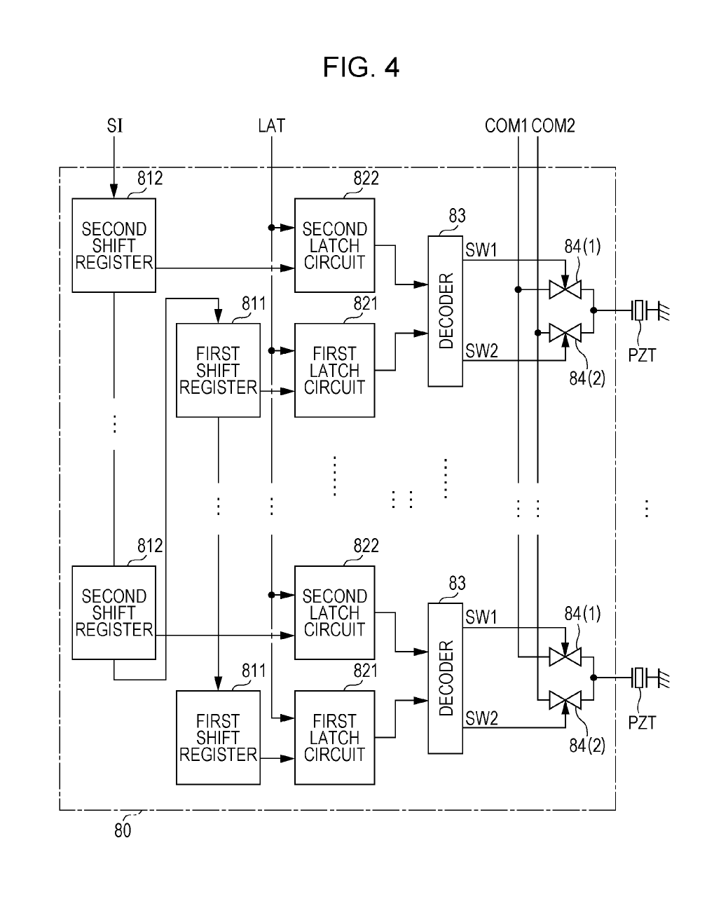

FIG. 3 is a view for explaining a first drive signal COM1 and a second drive signal COM2 which drive a piezoelectric element PZT, and FIG. 4 is a view for explaining a head drive circuit 80 (corresponding to the control unit). In the present embodiment, each of the nozzles Nz provided in the head 41 can form three different sizes of dots (large dot, medium dot and small dot), and one pixel on the medium S is expressed using four gradations. A period while one pixel (unit area in which one dot is formed) on the medium S opposes one nozzle Nz is referred to as a “repetition period T”. As illustrated in FIG. 3, a period from a certain rising pulse to the next rising pulse in a latch signal LAT corresponds to the repetition period T.

In the first drive signal COM1, a micro-vibration waveform Wb and an ejection waveform Wa are generated one by one for every repetition period T. In the repetition period T, the micro-vibration waveform Wb is generated at a time period t11, and the ejection waveform Wa is generated at a time period t12. On the other hand, in the second drive signal COM2, two ejection waveforms Wa are generated for every repetition period T. In the repetition period T, the ejection waveforms Wa are respectively generated at a time period t21 and a time period t22, and an electric potential does not vary at a time period t23. Then, depending on the dot size to be formed by the nozzles Nz, the waveforms Wa and Wb generated by the drive signals COM1 and COM2 are appropriately applied to the piezoelectric elements PZT that corresponds to the nozzles Nz, in this case, the ink having the amount depending on the dot size is ejected from the nozzles Nz, or the ink is not ejected from the nozzles Nz. In addition, in this embodiment, the piezoelectric elements PZT are driven by two types of drive signals COM1 and COM2, but without being limited thereto, the piezoelectric elements PZT may be driven by one type of drive signal COM, for example.

The ejection waveform Wa is a waveform applied to the piezoelectric element PZT so as to eject the ink from the nozzle Nz. The ejection waveform Wa has a first expansion element S1 for lowering the electric potential from an intermediate electric potential Vc to a first lowest electric potential Vla, a second contraction element S2 for rising the electric potential from the first lowest electric potential Vla to a first highest electric potential Vha, and a third element S3 for returning the electric potential from the first highest electric potential Vha to the intermediate electric potential Vc. If the first expansion element S1 is applied to the piezoelectric element PZT, the pressure chamber 411 is expanded. Thereafter, if the second contraction element S2 is applied to the piezoelectric element PZT, the pressure chamber 411 is rapidly contracted, and thereby the ink droplets are ejected from the nozzle Nz. Finally, if the third element S3 is applied to the piezoelectric element PZT, the volume of the pressure chamber 411 returns to its original state.

On the other hand, the micro-vibration waveform Wb does not cause the ink to be ejected from the nozzle Nz, and causes the ink inside the nozzle Nz to be minutely vibrated. The micro-vibration waveform Wb has a fourth expansion element S4 (corresponding to the first element) for lowering the electric potential from the intermediate electric potential Vc to a second lowest electric potential Vlb, a fifth hold element S5 for holding the second lowest electric potential Vlb, and a sixth contraction element S6 (corresponding to the second element) for raising the electric potential from the lowest electric potential Vlb to the second intermediate electric potential Vc. The pressure chamber 411 is expanded by applying the fourth expansion element S4 to the piezoelectric element PZT, and a meniscus (free surface of the ink, which is exposed from the nozzle opening) of the nozzle Nz, is drawn into the pressure chamber 411 side. Thereafter, the meniscus is freely vibrated over a period during when the fifth hold element S5 is applied to the piezoelectric element PZT so that the ink inside the nozzle Nz is minutely vibrated to the extent that the ink is not ejected from the nozzle Nz. As a result, the ink inside the nozzle Nz is stirred to suppress the thickening of the ink inside the nozzle Nz. Finally, if the sixth contraction element S6 is applied to the piezoelectric element PZT, the pressure chamber 411 is contracted, and thereby the vibration of the meniscus being suppressed, and then returns to its original state.

Next, a flow until when the waveforms Wa and Wb generated by the drive signals COM1 and COM2 are applied to the piezoelectric element PZT will be described. As illustrated in FIG. 4, for each nozzle Nz (that is, for each piezoelectric element PZT) a head drive circuit 80 included in the head unit 40 has a first shift register 811 (first SR in FIG. 4), a second shift register 812 (second SR in FIG. 4), a first latch circuit 821, a second latch circuit 822, a decoder 83, a first switch 84 (1) and a second switch 84 (2).

First, a dot data SI having a certain repetition period T is serially transmitted to the head drive circuit 80 from the controller 10. The dot data SI is data indication a dot size formed in the pixel on the medium S by the nozzle Nz or data indicating that the dot will not be formed, and is two bits data per one pixel. More specifically, any one of data (11) indicating a “large dot formation”, data (10) indicating a “medium dot formation”, data (01) indicating a “small dot formation” and, and data (00) indicating “no dot” is indicated with respect to one pixel. In the dot data SI which is serially transmitted, a high-order bit in the two-bit data allocated to each nozzle Nz is set to the first shift register 811, and a low-order bit is set to the second shift register 812.

Next, at the timing when the rising pulse is generated in the latch signal LAT, the first latch circuit 821 latches the data set in the first shift register 811, and the second latch circuit 822 latches the data set in the second shift register 812. As a result, the dot data SI that is transmitted from the controller serial 10 becomes a two-bit data group which is allocated to each nozzle Nz.

Next, switch control signals SW1 and SW2 are output by the decoder 83, based on the dot data SI from the first latch circuit 821 and the second latch circuit 822. The switch control signal SW1 and SW2 indicate on/off operations of the first switch 84 (1) and the second switch 84 (2). In addition, the drive signal COM1 is input to the first switch 84 (1) and the second drive signal COM2 is input to the second switch 84 (2). That is, based on the switch control signals SW1 and SW2, each of the first switch 84 (1) and the second switch 84 (2) performs the on/off operations, and thereby each of the waveforms wa and wb generated by each of the drive signals COM1 and COM2 is applied to the piezoelectric element PZT or blocked.

For example, in a case where the dot data SI indicates the “large dot formation (11)”, as illustrated in FIG. 3, the first switch 84 (1) blocks the micro-vibration waveform Wb during the time period t11 and applies the ejection waveform Wa to the piezoelectric element PZT during the time period t12. The second switch 84 (2) applies the ejection waveform Wa to the piezoelectric element PZT during the time periods t21 and t22 and blocks a wave during the time period t23 (wave maintaining the second intermediate electric potential Vc). That is, the ejection waveform Wa is applied to the piezoelectric element PZT three times and the ink droplets from the nozzle Nz are ejected three times. As a result, the large dot is formed.

In addition, in a case where the dot data SI indicates the “medium dot formation (10)”, the first switch 84 (1) blocks the micro-vibration waveform Wb and applies the ejection waveform Wa to the piezoelectric element PZT during the time period t12. The second switch 84 (2) applies the ejection waveform Wa to the piezoelectric element PZT during the time period t21 and blocks the ejection waveform Wa during the time period t22. As a result, the ejection waveform Wa is applied to the piezoelectric element PZT twice and the ink droplets from the nozzle Nz are ejected twice to form the medium dot.

In addition, in a case where the dot data SI indicates the “small dot formation (01)”, the first switch 84 (1) blocks both of the micro-vibration waveform Wb and the ejection waveform Wa. The second switch 84 (2) blocks the ejection waveform Wa during the time period t21 and applies the ejection waveform Wa to the piezoelectric element PZT during the time period t22. As a result, the ejection waveform Wa is applied to the piezoelectric element PZT once and the ink droplets from the nozzle Nz are ejected once to form the small dot.

In addition, in a case where the dot data SI indicates “no dot (00)”, the first switch 84 (1) applies the micro-vibration waveform Wb to the piezoelectric element PZT during the time period t11 and blocks the ejection waveform Wa. The second switch 84 (2) blocks the two ejection waveforms Wa. As a result, only the micro-vibration waveform Wb is applied to the piezoelectric element PZT, and the ink droplets are not ejected from the nozzle Nz and the ink inside the nozzle Nz is minutely vibrated.

As above, in the Embodiment 1, the head drive circuit 80 applies the micro-vibration waveform Wb to the piezoelectric element PZT corresponding to the nozzle Nz to which the pixel without forming the dot is allocated. In other words, the head drive circuit 80 applies the micro-vibration waveform Wb to the piezoelectric element PZT corresponding to the nozzle Nz which does not eject the ink onto the medium S, drives the piezoelectric element PZT, and generates the pressure change in the ink inside the pressure chamber 411 corresponding to the piezoelectric element PZT, whereby adding the vibration, having a size which does not allow the ink to be ejected from the nozzle Nz to the ink inside the nozzle Nz.

Accordingly, as is the printer 1 of the present embodiment, even in a case where the heater 51 is provided in the vicinity of the head 41 and the nozzle Nz is easily clogged, since the thickening of the ink inside the nozzle Nz can be suppressed by minutely vibrating the ink inside the nozzle Nz which does not eject the ink, the nozzle Nz clogging can be suppressed. As a result, it is possible to eject a prescribed amount of the ink from the nozzle Nz and to land the ink at a desired position on the medium S. Therefore, it is possible to suppress the degradation of the image in quality.

### Print Method

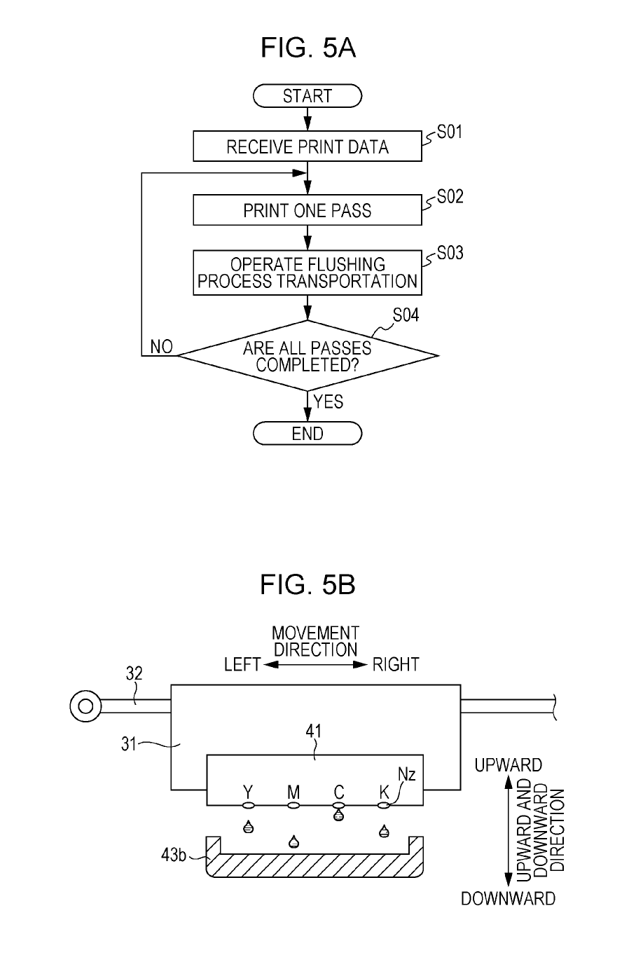

FIG. 5A is a flow chart illustrating a printing method in Embodiment 1 and FIG. 5B is a view for explaining a flushing process. If the controller 10 receives the printing data from the computer 70 (S01), the controller 10 set the medium S to a printing start position using the transportation unit 20 and then causes the ink to be ejected from the nozzle Nz provided in the head 41 so as to print an image (a part) on the medium S while moving the head 41 sealed by the cap 44 disposed on a home position (here, right side non-print region in the movement direction) to the left side in the movement direction using the carriage 31. That is, one pass printing is performed (S02).

After one pass printing, as illustrated in FIG. 5B, the controller 10 causes to face the ink reception unit 43b disposed at the left side non-print region in the movement direction and the lower surface of the head 41 to oppose each other. Then, during when the medium S is transported to the downstream side in the transportation direction using the transportation unit 20, the controller 10 performs the “flushing process” which is a cleaning process of the head 41 (S03). The flushing process refers to a process of forcibly ejecting the ink from the nozzle Nz provided in the head 41 onto the ink reception units 43a and 43b. For example, the ink is forcibly ejected from the nozzle N by applying the ejection waveform Wa illustrated in FIG. 3 to the piezoelectric element PZT over the multiple times. As a result, it is possible to eject from the nozzle Nz the ink thickened or the foreign matter mixed in the nozzle Nz during the one pass printing. That is, it is possible to solve the problem of the nozzle Nz clogging. Accordingly, it is possible to perform the next pass printing in a state where the nozzle Nz is not clogged. Therefore, it is possible to suppress the degradation in the image quality.

If there is the next pass (S04: No), the controller 10 causes the ink to eject from the nozzle Nz while moving the head 41 again to the right side in the movement direction so as to print the image (one part) on the medium S (S02). Then, the controller 10 performs the flushing process by causing the ink reception unit 43a disposed in the non-print region at the right side in the movement direction and the lower surface of the head 41 to oppose each other. The controller 10 repeats a series of processes until the all pass printings are finished (S04: Yes).

As described above, in Embodiment 1, for every time of moving the head 41 in the movement direction, the controller 10 causes the ink to be ejected from the nozzles Nz onto the ink reception units 43a and 43b in the non-print regions at both sides in the movement direction. In other words, the flushing process is performed for each one pass printing. As in the printer 1 of the present embodiment, even in a case where the heater 51 is disposed in the vicinity of the head 41 and thereby the nozzle Nz is easily clogged, it is possible to eject the thickened ink or the foreign matter from the nozzle Nz using the flushing process for each pass, and thereby it is possible to suppress the nozzle Nz clogging. As a result, it is possible to suppress the degradation in the image quality.

In addition, a method (so-called a bidirectional printing) of printing an image even when the head 41 moves to the left side in the movement direction and even when moving to the right side in the movement direction is described above as an example, but without being limited thereto, a method (so-called unidirectional printing) of printing an image only when the head 41 moves to one side in the movement direction may be performed. Even in this case, for each time the head 41 moves once in the movement direction, the flushing process may be performed in the non-print regions in the movement direction.

### Strength of Micro-Vibration Waveform Wb

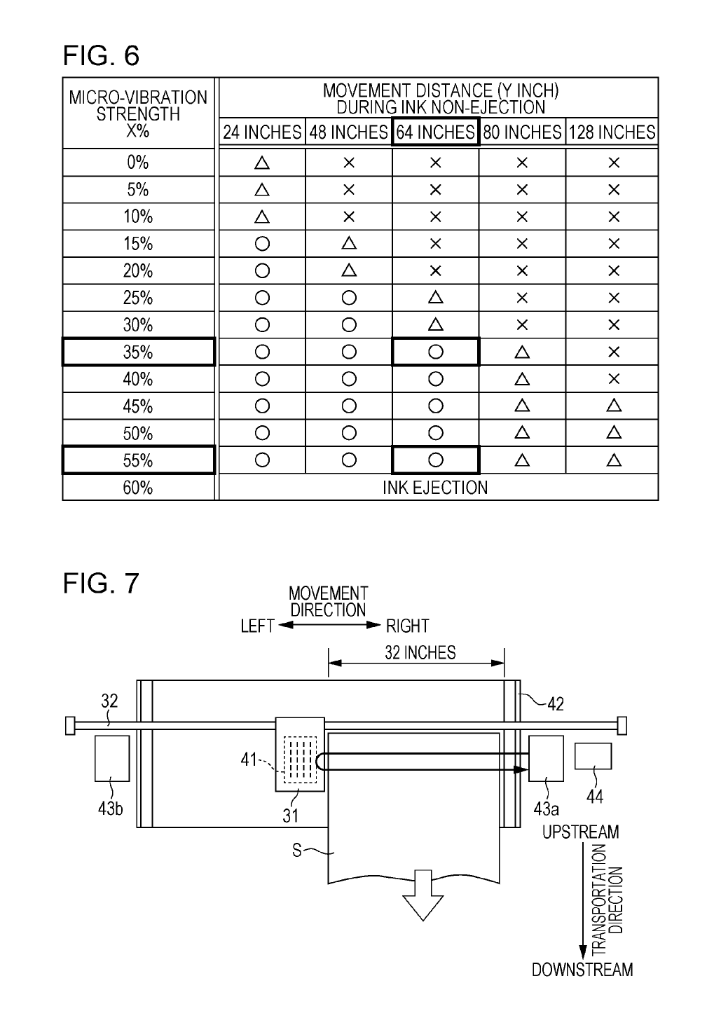

FIG. 6 is a table illustrating results of evaluating the states of the ink ejection from the nozzle Nz by changing the strength of the vibration waveform Wb and the movement distance of the head 41. As the amount of electric potential change in the fourth expansion element S4 of the micro-vibration waveform Wb illustrated in FIG. 3 is increased (that is, as the electric potential difference between the intermediate electric potential Vc and the second lowest electric potential Vlb is increased), the pressure chamber 411 is greatly expanded, and the meniscus of the nozzle Nz is also greatly drawn into the pressure chamber 411 side, and thereby the micro-vibration (amplitude) of the ink inside the nozzle Nz is also greatly increased. Therefore, it is possible to reliably suppress the nozzle Nz clogging. However, if the amount of the electric potential change in the fourth expansion element S4 is exceedingly increased, the ink is ejected from the nozzle Nz. Therefore, in order that the ink may not be ejected from the nozzle Nz, it is necessary to set the strength of the micro-vibration waveform Wb so as to suppress the nozzle Nz clogging.

Therefore, in the printer 1 of present embodiment, by changing the strength (X %) of the micro-vibration waveform Wb and the movement distance (Y inch) of the head 41, the state of the ink ejection from the nozzle Nz was evaluated. More specifically, “the percentage X % of the electric potential difference between the intermediate electric potential Vc of the micro-vibration waveform Wb and the second lowest electric potential Vlb” to “the electric potential difference (100%) between the first highest electric potential Vha of the ejection wave Wa and the first lowest electric potential Vla” was changed by 5% increment each from 0% to 60%. Then, the micro-vibration waveform Wb having the strength of X % was applied to the piezoelectric element PZT for each of the repeated periods T, that is, the ink inside the nozzle Nz was minutely vibrated. Concurrently, after the head 41 was moved by a predetermined distance (Y inch) in the movement direction, the ejection waveform Wa was applied to the piezoelectric element PZT to eject the ink onto the target position on the medium S from the nozzle Nz. In addition, the fact that the strength X % of the micro-vibration waveform Wb is 0% means that the micro-vibration was not applied to the ink inside the nozzle Nz at all.

After the head 41 was moved by a predetermined distance (Y inch) in the movement direction, the ink was ejected from the nozzle Nz using the ejection waveform Wa firstly applied to the piezoelectric element PZT, and an evaluation on a case where the amount of deviation between the landing position and the target position of the ink was 100 μm or less was regarded as “◯ (pass)”, and the ink was ejected from the nozzle Nz using the ejection waveform Wa firstly applied to the piezoelectric element PZT. In contrast, an evaluation on a case where the amount of deviation between the landing position and the target position of the ink was 100 μm or more was regarded as “Δ”, and an evaluation on a case where the ink was not ejected from the nozzle Nz using the ejection waveform Wa firstly applied to the piezoelectric element PZT was regarded as “×”.

As a result, in a case where the micro-vibration strength X % is 60% (that is, the electric potential difference between the second intermediate electric potential Vc and the lowest electric potential Vlb of the micro-vibration waveform Wb is 60% of the electric potential difference between the first highest electric potential Vha and first lowest electric potential Vla of the ejection waveform Wa), the ink was ejected from the nozzle Nz since the vibration of the ink inside the nozzle Nz was too strong.

In addition, if the distance (Y inch) which had caused the nozzle Nz to move without ejecting the ink was “80 inches and 128 inches”, the evaluation on “◯ (pass)” could not be obtained in any strength (0% to 55%) of the micro-vibration waveform Wb.

If the distance (Y inch) which had caused the nozzle Nz to move without ejecting the ink was “64 inches”, the evaluation on “◯ (pass)” could be obtained when the strength X % of the micro-vibration waveform Wb was in a range of “35% to 55%” of the micro-vibration waveform Wb.

If the movement direction (Y inch) of the nozzle Nz which is movable without the ejection of the ink is “48 inches”, the evaluation on “◯ (pass)” could be obtained when the strength X % of the micro-vibration waveform Wb is in a range of “25% to 55%”.

if the distance (Y inch) which had caused the nozzle Nz to move without ejecting of the ink was “24 inches”, the evaluation on “◯ (pass)” could be obtained when the strength X % of the micro-vibration waveform Wb was in a range of “15% to 55%”.

As described above, in the printer 1 of the embodiment, the maximum length in the movement direction of the printable medium S is 64 inches. Further, as described in the flow of FIG. 5A, in Embodiment 1, each time the head 41 is moved once in the movement direction, the flushing process is performed in the non-print regions at both sides in the movement direction. Therefore, while the nozzle Nz is moved by 64 inches in the movement direction, the ink is not ejected from the nozzle Nz. Even though the ink inside the nozzles Nz is minutely vibrated using the micro-vibration waveform Wb of a certain X % strength, the clogging does not occur in the nozzle Nz. In this case, there is no problem even if the strength of the micro-vibration waveform Wb is set to the strength X %. Therefore, based on the evaluation results in FIG. 6, in the printer 1 of the present embodiment, the strength X % of the micro-vibration waveform Wb may be set within a range of “35% to 55%”.

That is, an upper limit value of the electric potential difference (that is, an electric potential change amount X % of the micro-vibration waveform Wb) between the second intermediate electric potential Vc (start end electrical potential) and the second lowest electric potential Vlb (terminal end electrical potential) of the fourth expansion element S4 in the micro-vibration waveform Wb is set to an electric potential difference which does not allow the ink to be ejected from the nozzle Nz. Specifically, the upper limit value of the electric potential difference between the intermediate electric potential Vc and the second lowest electric potential Vlb of the fourth expansion element S4 is set to 55% of the electric potential difference (100%) between the first highest electric potential Vha and the first lowest electric potential Vla in ejection waveform Wa.

In this manner, it is possible to prevent the ejection of the ink from the nozzle Nz onto the pixel which is not supposed to have dots, and thereby it is possible to suppress degradation in the image quality.

In addition, the lower limit value of the electric potential difference (X %) between the intermediate electric potential Vc and the second lowest electric potential Vlb of the fourth expansion element S4 is set to 35% of the electric potential difference (100%) between the first highest electric potential Vha and the first lowest electric potential Vla in the ejection waveform Wa.

In this manner, while the head 41 is moved once in the movement direction so as to print an image on the medium S which has the maximum length 64 inches in the movement direction, even though the nozzle Nz from which does not allow the ink to be ejected is present over a relatively long period of time, the nozzle Nz clogging can be prevented. Accordingly, the ink of a prescribed amount of the ink can be ejected from the nozzle Nz, and thereby the ink can be landed on the target position. Therefore, it is possible to suppress the degradation in the image quality.

### Embodiment 2

FIG. 7 is a view for explaining a printing method according to Embodiment 2. In Embodiment 1, each time the head 41 is moved once in the movement direction, the flushing process is performed in the non-print regions at both sides in the movement direction. In this case, even if the length of the printing target medium S or the length of the image in the movement direction is short, the head 41 has to move from the ink reception unit 43a which is located at the right end in the movement direction to the ink reception unit 43b which is located at the left end in the movement direction. Therefore, in Embodiment 2, depending on the length of the printing target medium S or the length of the image in the movement direction, the movement distance of the head 41 is changed.

For example, as illustrated in FIG. 7, in a case where the right end of the medium S to transported by being aligned to the right end of the platen 42, the head 41 may print an image while moving to the left side in the movement direction from the ink reception unit 43a which is located at the right end in the movement direction to the position beyond the left end of the medium S. Thereafter, the head 41 may print the image returning from the position beyond the left end of the medium S to the right end in the movement direction. Further, the head 41 may return from the position beyond the left end of the printed image. Then, the flushing process is performed in the ink reception unit 43a located at the right end in the movement direction. By doing so, the distance that the head 41 moves in a single pass can be shortened, and thereby the printing time can be shortened.

That is, in Example 2, when the controller 10 moves the head 41 to one side in the movement direction and thereafter causes the head 41 to return to the non-print region of the other side in the movement direction, the controller 10 causes the ink to be ejected onto the ink reception unit 43a from the nozzle Nz. However, in the printer 1 of the present embodiment, the heater 51 is provided in the vicinity of the head 41 and thus the nozzle Nz is easily clogged. Therefore, if the medium S (or printed image) has such a length that the nozzle Nz clogging does not occur, even though the ink inside the nozzle Nz is minutely vibrated using the micro-vibration waveform Wb during when the head 41 reciprocates on the medium S (or print image), the movement distance of the head 41 may be changed depending on the length of the medium S (printed image) in the movement direction. In this manner, the nozzle Nz clogging can be suppressed while shortening the printing time as much as possible.

### Other Embodiment

Embodiments described above are to facilitate the understanding of the present invention, and are not to be construed as limiting the present invention. The present invention may be modified and improved without departing from the spirit thereof, and may include the equivalent thereof.

In the embodiment described above, the flushing process is performed out for each pass, but without being limited thereto, the flushing process may not be performed.

In the embodiments described above, although an example of the operation of the printer 1 which repeats an operation of ejecting the ink while moving the head 41 in the movement direction and an operation of transporting the medium S in the transportation direction is described above, but is not limited thereto. For example, with respect to the medium S that is transported to the print region, the printing apparatus may repeat an operation of printing the image while moving the head in the X-direction and an operation of moving the head in the Y-direction, may print the image and thereafter, may be transport a part of the sheet S where the image is not yet printed, to the print region.

In the embodiment described above, a method of ejecting the ink from the nozzles Nz by applying the ejection waveform to the piezoelectric element PZT to expand and contract the pressure chambers 411 is exemplified, but is not limited thereto. For example, the ejecting method may be a thermal method of ejecting the ink from the nozzle using bubbles generated within the nozzle by means of a heater element.

What is claimed is:

1. A printing apparatus comprising:
a head including a nozzle ejecting an ink which includes thermoplastic resin particles and has a viscosity of 2.1 mPa·s or more at 50° C., a pressure chamber communicating with the nozzle, and a drive element corresponding to the nozzle and the pressure chamber;
a medium which has ink-unabsorbable characteristics and a length of 64 inches or less in a predetermined direction;
a movement mechanism which moves the head in the predetermined direction;
a heating unit which heats the medium; and
a control unit which causes the movement mechanism to move the head in the predetermined direction and applies a drive waveform generating a pressure change in the ink inside the pressure chamber, to the drive element,
wherein the control unit applies a micro-vibration waveform having a size which does not allow the ink to be ejected from the nozzle onto the drive element corresponding to the nozzle if the nozzle do not eject the ink.

2. The printing apparatus according to claim 1,
wherein the micro-vibration waveform includes a first element which expands the pressure chamber and a second element which contracts the pressure chamber and wherein an upper limit value of an electric potential difference between a boiling point and a termination end electric potential of the first element is an electric potential difference which does not allow the ink to be ejected from the nozzle.

3. The printing apparatus according to claim 1,
wherein the micro-vibration waveform includes a first element which expands the pressure chamber and a second element which contracts the pressure chamber, and
wherein a lower limit value of an electric potential difference between a boiling point and a termination end electric potential of the first element is 35% of an electric potential difference between the highest electric potential and the lowest electric potential in an ejection waveform applied to the drive element when the ink is ejected from the nozzle.

4. The printing apparatus according to claim 1,
wherein ink reception units receiving the ink ejected from the nozzle are disposed in non-print regions at both sides in the predetermined direction, and
wherein the control unit causes the ink to be ejected from the nozzle toward the ink reception units in the non-print regions at both sides in the predetermined direction each time the movement mechanism moves the head in the predetermined direction.

5. The printing apparatus according to claim 1,
wherein ink reception units receiving the ink ejected from the nozzle is disposed in non-print regions at both sides in the predetermined direction, and
wherein the control unit causes the ink to be ejected from the nozzle toward the ink reception units after causing the movement mechanism to move the head to one side in the predetermined direction, when moving the head to return to the non-print region of the other side in the predetermined direction.

6. A method of printing an image on a medium which has ink-unabsorbable characteristics and a length of 64 inches or less in a predetermined direction by using a head including a nozzle ejecting an ink which includes thermoplastic resin particles and has a viscosity of 2.1 mPa·s or more at 50° C., a pressure chamber communicating with the nozzle, and a drive element corresponding to the nozzle and the pressure chamber, the method comprising:
moving the head in the predetermined direction, toward the medium which is being heated; and
applying a drive waveform generating a pressure change in the ink inside pressure chamber to a drive element; and
wherein the control unit applies a micro-vibration waveform having a size which does not allow the ink to be ejected from the nozzle onto the drive element corresponding to the nozzle if the nozzle do not eject the ink.
